(19) United States
(12) Patent Application Publication
(10) Pub. No.: US 2012/0150702 A1
(43) Pub. Date: Jun. 14, 2012

(54) METHOD AND SYSTEM FOR PREPARATION OF ACCOUNTING DATA

(75) Inventors: Gerhard Schneider, Offenbach (DE); Marco Nonn, Offenbach (DE); Roger Zacharias, Bad Nauheim (DE); Nico vom Hagen, Bad Nauheim (DE)

(73) Assignee: WINCOR NIXDORF INTERNATIONAL GMBH, Paderborn (DE)

(21) Appl. No.: 12/988,647

(22) PCT Filed: Mar. 31, 2009
(86) PCT No.: PCT/EP2009/053795

§ 371 Date: Oct. 20, 2010

(30) Foreign Application Priority Data
Apr. 22, 2008 (DE) 10 2008 020 206.1

(51) Int. Cl. G06Q 40/00

(52) U.S. Cl. 705/30

(57) ABSTRACT

In the preparation of accounting data for transactions involving money on at least one money transfer system, in particular on an automated teller machine, data is exchanged using the so-called SWIFT code, for example. The management system normally produces the accounting data in a standard form for all transaction following a format such as this. For flexible preparation of accounting data for different financial institutes, it is now proposed that the system comprise a conversion device (PTSIA) which is connected to the management system (CCMS) in order to prepare the accounting data in different ways for different financial institutes (B1, B2, . . . ) through the conversion device (PTSIA) for the respective financial institute (B1) converting the first accounting data items (D-IN) into second accounting data items as a function of presets (TMPL), wherein the presets (TMPL) indicate at least one format (DTA) desired by the financial institute (B1) for the second accounting data items (D-OUT).

### CROSS-REFERENCE TO RELATED APPLICATIONS

This application is a National Stage of International Application No. PCT/EP2009/053795, filed Mar. 31, 2009. This application claims the benefit and priority of German application 10 2008 020 206.1, filed Apr. 22, 2008. The entire disclosures of the above applications are incorporated herein by reference.

### BACKGROUND

This section provides background information related to the present disclosure which is not necessarily prior art.

### TECHNICAL FIELD

The invention relates to a method for the preparation of accounting data in accordance with the preamble of claim 1 and a system for carrying out the method in accordance with the preamble of the subordinate claim.

### DISCUSSION

The invention relates in particular to a method and system for the preparation of accounting data for transactions involving money on at least one money transfer system, in particular on an automated teller machine, wherein transactions are performed for different financial institutes whereby first accounting data are generated for each transaction by a management system.

All types of systems and institutions are understood as money transfer systems (also described as “cash points”) at which transactions of money (bank notes, coins) are carried out in the form of deposits and/or withdrawals, for example, automated teller machines, cashier's safes and similar. Normally, a management system (also as described as “cash cycle management system”) monitors the transactions wherein accounting data are generated and prepared for the financial institutes involved or other organizations (valuables transport companies, major customers, etc.). The exchange of data is handled in accordance with the SWIFT code, for example, or in accordance with the DTA standard. Normally, the management system generates the accounting data uniformly for all transactions using one such format. It would be desirable to create a method and a system for the flexible preparation of accounting data for different financial institutes. The term “financial institution” is used here as an example for any type of organization that is involved in transactions and will hereinafter also be described as the “client” of the management system.

### SUMMARY OF THE INVENTION

It is, therefore, an object of the present invention to propose a solution for a flexible preparation of accounting data that is suitable for transactions where different financial institutions participate.

It is accordingly proposed to prepare the accounting data differently by a conversion device linked with the management system for the various financial institutes by converting the first accounting data generated by the management system for the particular financial institute into second accounting data as a function of presets, wherein the presets indicate at least one format desired by the financial institute for the second accounting data.

Thus, a method and system created for several clients (financial institutes and other organizations) is proposed that generates client-specific accounting data or data records compiled from said data and provides said data for the specific client in accordance with his presets.

The system for preparing accounting data in accordance with the invention is distinguished in that it encompasses a conversion device linked to the management system to prepare the accounting data differently for the different financial institutions by the conversion device for the specific financial institute converting the first accounting data as a function of presets, where the presets indicate at least one format desired by the financial institute for the second accounting data.

Accordingly, the first accounting data are preferably transmitted by the management system to the conversion device and transferred to a representation that corresponds to a convention for a program-driven structuring of the first accounting data. This representation is preferably shown in a markup language, specifically the expandable markup language meeting the XML specification. The presets are preferably given in a programming language for the transformation of data, or the files created therefrom that exist in the representation specifically as XML data or files. In this context, the XSL transformation, XLST for short, is used as the programming language to convert the XML data or files.

The presets are preferably polled by the conversion device at a configuration service. The preparation of the accounting data preferably takes place such that the presets for the specific financial institution are polled at the configuration service and imported by the conversion device, and then the conversion of the first accounting data into the second accounting data is carried out using the imported presets. The presets are preferably saved as templates for the specific client.

The conversion of the first accounting data into the second accounting data can now be preferably performed by converting the representation (e.g. as XML files) for the first accounting data by means of the presets or templates given in the programming language (e.g. XSLT) in the second accounting data.

The accounting data are preferably generated and prepared in the form of accounting data records (e.g. with information about bank account, contra account, amount, date) wherein the accounting data record with the second accounting data has at least a format dictated by the presets.

The accounting data are specifically prepared for an accounting system to which the specific client or financial institute has access, where the second accounting data are prepared for the specific financial institute by saving the second accounting data for the accounting system for retrieval as required and/or transmitting said data to the accounting system.

For the event that no presets or templates for the second accounting data are available from the specific client, the second accounting data are converted in accordance with a standard template that corresponds, for example, to the DTA standard used in particular in Germany.

The method and system can be expanded in such a way that the first and/or second accounting data are processed in data records that comprise several transactions each. The first and/or second accounting data can also be processed in data records that are located in several data fields and/or partial data records. Said partial records can, for example, be C-records that correspond to individual transactions. They are compiled in the specific accounting record; one accounting record thus contains a collection of individual accounting transactions.

### BRIEF DESCRIPTION OF THE DRAWINGS

The invention is explained hereinafter using one embodiment, with reference being made to the accompanying drawings that represent the following.

The drawings described herein are for illustrative purposes only of selected embodiments and not all possible implementations, and are not intended to limit the scope of the present disclosure.

FIG. 1 shows the schematic structure of a system in accordance with the invention.

FIG. 2 shows a flow chart for a method in accordance with the invention.

Corresponding reference numerals indicate corresponding parts throughout the several views of the drawings.

### DETAILED DESCRIPTION OF THE PREFERRED EMBODIMENTS

Example embodiments will now be described more fully with reference to the accompanying drawings.

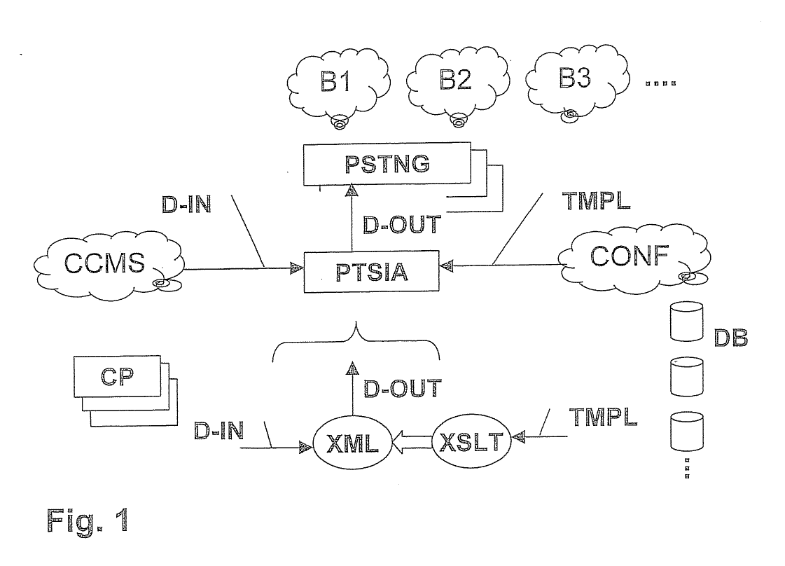

The system shown in FIG. 1 comprises a CCMS management system that manages transactions for various financial institutes B1, B2, B3, etc. that can be exported to several money transfer systems (CP). Accounting data D-IN are generated by the CCMS management system for each transaction. These data would be transmitted in the conventional manner to at least one accounting system PSTNG to which the financial institutes, or clients, have access. The PSTNG accounting system can be, for example, a central accounting system for one or more banks.

In accordance with the invention, under the control of the CCMS management system the first accounting data D-IN are converted into second accounting data D-OUT and made available by specific client to the PSTNG accounting system, by data carrier (tape, diskette) and/or by on-line exchange of data.

The system further has available a conversion device PTSIA linked to the CCMS management system that can be located separately from the management system or integrated into the management system. The conversion device PTSIA comprises an arithmetic unit (not shown) that, program-controlled, generates the second accounting data D-OUT from the first accounting data D-IN in accordance with at least one preset TMPL and provides said data for the PSTNG accounting system. A separate template TMPL can be filed for each client B1, B2, . . . in the configuration service CONF.

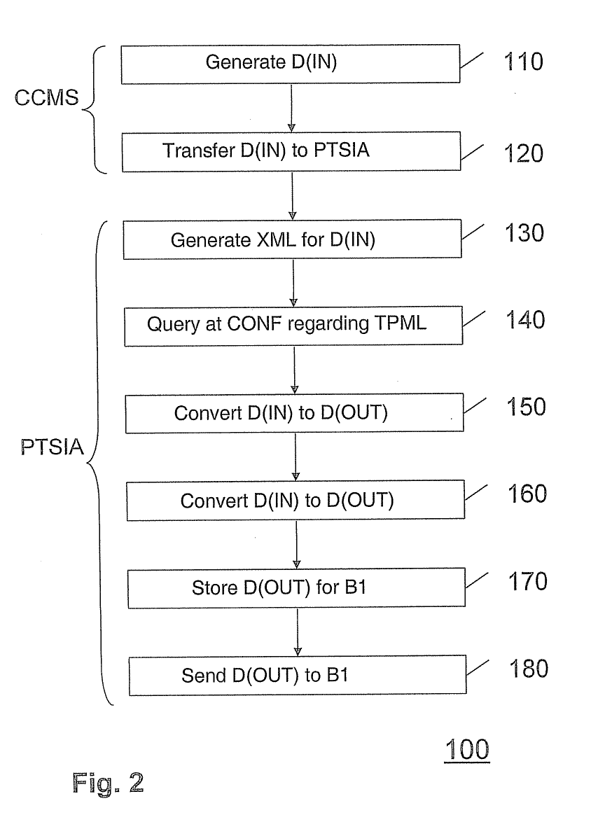

The method employed is now explained in greater detail here using FIG. 2, wherein reference is made further to FIG. 1:

The method 100 comprises several steps 110 to 180, wherein the first steps 110 and 120 are performed by the management system CCMS, and the subsequent steps 130 to 180 are essentially performed by the conversion device PTSIA.

In a first step 110, the first accounting data D-IN are initially generated in the conventional way. For example, the data are generated as data records that contain transaction data, for example regarding bank account, contra account, amount and date. Then these data, or data records D-IN, are transmitted to the conversion device PTSIA, which in a step 130 first converts the data into a representation conforming to XML specification. Thus, the accounting data, or data records derived from them in each case, are available in the corresponding text format and can be interpreted by means of a program-controlled process for any application.

In a next step 140, to transform the data D-IN the conversion device PTSIA asks for presets TMPL that, for example, are on file at a configuration service CONF for the and/or from the specific client, as for example bank B1. The configuration service CONF has in particular one or more databases DB in which the presets are filed preferably as templates.

The conversion device PTSIA polls the specific preset(s) for the particular client from the configuration service and reads them in a step 150. Depending on this step, the input data, or data record D-IN, are converted into the output data, or the data record D-OUT, respectively.

By using XML files and the use of the programming language XSLT, a very flexible and optimally customized preparation of accounting data, or accounting data records, is achieved for the particular client B1, B2, B3, etc. In particular, the storage and transmission of the desired presets TMPL can be implemented by means of XML-capable standard components and interfaces, which means that only text-format capable resources are required. The multi-client solution proposed here can also be implemented economically and universally.

The transformed output data D-OUT are saved, for example, in the accounting system PSTNG or in the management system CCMS (step 170) and can be sent to the particular client as needed (step 180) or held in readiness for retrieval.

The foregoing description of the embodiments has been provided for illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A method for the preparation of accounting data (D-IN, D-OUT) for transactions involving money on at least one money transfer system (CP) that carries out transactions for various financial institutes (B1, B2, . . . ), wherein first accounting data (D-IN) are generated by a management system (CCMS) for each transaction involving money, characterized in that the accounting data are prepared differently for the various financial institutes (B1, B2, . . . ) by a conversion device (PTSIA) linked to the management system (CCMS) through the first accounting data (D-IN) being converted into second accounting data (D-OUT) for the particular financial institute (B1) as a function of presets (TMPL), wherein the presets (TMPL) indicate at least one format (DTA) desired by the financial institute (B1) for the second accounting data (D-OUT).

2. The method from claim 1, wherein the first accounting data (D-IN) are transmitted by the management system (CCMS) to the conversion device (PTSIA) and then transferred by the conversion device (PTSIA) into a representation (XML) that corresponds to a convention for a program-controlled structuring of the first accounting data (D-IN).

3. The method from claim 2, wherein the representation (XML) corresponds to a mark-up language, in particular the expandable mark-up language meeting the XML specification.

4. The method from claim 1, wherein the presets (TMPL) are given in a programming language (XSLT) for the transformation of such data, or of files formed therefrom, that are present in the representation (XML).

5. The method from claim 4, wherein the programming language (XSLT) is suitable for the transformation of XML data or files.

6. The method from claim 1, wherein the presets (TMPL) are polled by the conversion device (PSTIA) at a configuration service (CONF).

7. The method from claim 1, wherein the presets (TMPL) for the particular financial institute (B1) are polled at the configuration service (CONF) and imported by the conversion device (PSTIA) and wherein the conversion of the first accounting data (D-IN) into the second accounting data (D-OUT) is performed using the presets (TMPL) that were imported.

8. The method from claims 2, wherein the conversion of the first accounting data (D-IN) into the second accounting data (D-OUT) is carried out by converting the representation (XML) for the first accounting data (D-IN) into the second accounting data (D-OUT) by means of the presets (TMPL) indicated in the programming language (XSLT).

9. The method from claim 1, wherein the conversion of the first accounting data (D-IN) into the second accounting data (D-OUT) takes place using accounting data records, wherein the accounting data record with the second accounting data (D-OUT) is in at least one format indicated by the presets (TMPL).

10. The method from claim 1, wherein the second accounting data (D-OUT) are prepared for the individual financial institute (B1) by saving the second accounting data (D-OUT) for an accounting system (PSTNG) to which the financial institute (B1) has access, and/or are transmitted to the accounting system (PSTNG).

11. The method from claim 1, wherein, in the event that no presets (TMPL) are available from the second accounting data (D-OUT), the second accounting data (D-OUT) are converted in accordance with a standard template.

12. The method from claim 1, wherein the first and/or second accounting data (D-IN; D-OUT) are processed in data records that respectively comprise several transactions.

13. The method from claim 1, wherein the first and/or second accounting data (D-IN; D-OUT) are processed in data records that are arranged in several data fields and/or partial data records.

14. The method for the preparation of accounting data (D-IN; D-OUT) for transactions involving money on at least one money transfer system (CP) that performs transactions for various financial institutes (B1, B2, . . . ), wherein first accounting data (D-IN) are generated by a management system (CCMS) for each transaction involving money, characterized in that the accounting data are prepared differently by a conversion device (PTSIA) linked to the management system (CCMS) for the various financial institutes (B1, B2, . . . ) by converting the first accounting data (D-IN) for the particular financial institute (B1) as a function of presets (TMPL) into second accounting data (D-OUT), wherein the presets (TMPL) indicate at least one format (DTA) desired by the financial institute for the second accounting data (D-OUT).

15. A system for the preparation of accounting data (D-IN; D-OUT) for transactions involving money on at least one money transfer system (CP) that performs transactions for various financial institutions (B1, B2, . . . ), wherein the system comprises a management system (CCMS) that generates first accounting data (D-IN) for each transaction involving money, characterized in that the system comprises a conversion device (PTSIA) linked to the management system (CCMS) in order to prepare the accounting data differently for the various financial institutes (B1, B2, . . . ) by the conversion device (PTSIA) for the particular financial institute (B1) converting the first accounting data (D-IN) into second accounting data (D-OUT) as a function of presets (TMPL), wherein the presets (TMPL) indicate at least one format (DTA) desired by the financial institute (B1) for the second accounting data (D-OUT).
